(19) United States
(12) Patent Application Publication
(10) Pub. No.: US 2024/0348886 A1
(43) Pub. Date: Oct. 17, 2024

(54) System and Method for Personalized Media Selection

(71) Applicant: Peter NAGLE, Washington, DC (US)

(72) Inventor: Peter NAGLE, Washington, DC (US)

(21) Appl. No.: 18/634,072

(22) Filed: Apr. 12, 2024

Related U.S. Application Data
(60) Provisional application No. 63/495,875, filed on Apr. 13, 2023.

(51) Int. Cl. H04N 21/482

(52) U.S. Cl. CPC H04N 21/482

(57) ABSTRACT

Methods of selecting one item from a population of items are presented. The methods use a sequence of binary choices to make the selection process more efficient. One such method is a tournament bracket type in which those chosen from each round are pitted against each other, and the victor moves to a subsequent round. In another, the victor of an initial selection is pitted against other options until the population is exhausted or the victor is replaced. In another method, each of the two choices are ranked by the degree of the users preference, and these rankings are used to construct further pairwise choices.

### FIELD OF THE INVENTION

The present disclosure is generally directed to methods and devices for choosing an item from a set. More particularly, the present disclosure pertains to methods and devices to assist a user choose an item of media from a set of similar or related media.

### BACKGROUND OF THE INVENTION

Since the advent of user-playable media, people have had to decide what they want to experience next.

As of December of 2022, the Internet Movie Database had entries for over 600,000 feature movies. https://en.wikipedia.org/wiki/IMDb. Of those, some portion is available on one or more of several licensed streaming and download services. In addition, streaming and download services contain a large number of TV shows and short films, as well as a nearly incalculable number of audiobooks available.

The number of selections available is dizzying. This can be great and awful. Some viewers are plagued by decision paralysis and have difficulty selecting something to watch because they think there is something better to be found with further perusal of a catalog.

Many streaming services present viewers with a selection of titles to watch next. The titles are often culled from a list derived from what other users with similar viewing backgrounds have watched. This may be more targeted than forcing a viewer to scroll through an entire catalog, but it can still present a substantial array of choices and promote decision paralysis.

The current selection guides are largely passive and constructed in response to what a user and other users flagged as similar have chosen in the past. They fail to take into account all the nuances of a viewer's taste, thereby creating an increasingly narrow profile. What a person would like to watch at any time is dependent on much more than their previous choices.

Even when a person wants to watch something similar to the last several movies they've seen, the movies suggested by an algorithm used by some streaming or download service are almost certainly constrained by what is available on the service. In other words, an automated suggestion algorithm is likely to only suggest movies that are somehow related and don't require the viewer to use a different service.

What is needed is a new method of assisted media selection that engages the user via the gamification of such decision-making. Other features and advantages will be made apparent from the present specification. The teachings disclosed extend to those embodiments that fall within the scope of the claims, regardless of whether they accomplish one or more of the above-mentioned needs.

### SUMMARY OF THE INVENTION

The subject matter of this application addresses these needs. The application discloses a method of selecting one or more items from a group using pairwise comparisons. The method presents a user with several iterations of paired choices from a set of items. Choices made at each iteration are used to create a subset of items. Iterations may continue to winnow the items in the subset, or the items within the subset may be ranked or sorted and presented to the user. Certain embodiments may also use one or more APIs to communicate with streaming or download services to acquire lists of available movies or to add selected movies to a queue.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF DRAWINGS

FIG. 1 illustrates the bracket choice embodiment of the subject matter of this application.

FIG. 2 illustrates a sequential choice embodiment of the subject matter of this application.

FIG. 3 illustrates a sliding choice embodiment of the subject matter of this application.

FIG. 4 illustrates a selection methodology comprising the subject matter shown in FIG. 1.

The same reference numbers will be used throughout the drawings to represent the same aspects wherever possible.

### DETAILED DESCRIPTION OF THE INVENTION

While the exemplary embodiments illustrated in the figures and described herein are presently preferred, these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions, and arrangement of the exemplary embodiments without departing from the scope of the present application.

Uses of the verbs ‘include’ and ‘have’ should be understood to mean ‘comprise,’ i.e., the terms are inclusive and open-ended and do not exclude additional elements or steps. For ease of drafting and understanding the subject matter of this application, the method is discussed and detailed as a way of selecting a movie. However, the disclosed method may be used as a decision aid when one is faced with a large number of possible selections and the possible ensuing decision paralysis. For example, instead of movies the method could be used to select books, music, and recipes.

In the disclosed system and method for personalized media selection, a user is presented with a series of binary choices between two movies selected from a set. As each choice is made, a subset of selected movies is identified. With repeated choices the subset is winnowed to contain several highly ranked movies. The subset may be used to select a movie, or the subset may be presented to the user for final selection.

In one highly preferred embodiment, the selection method is implemented on a computer or similar device such as a smartphone or tablet (any one of which is a “local computer”). A set of movies may be either stored on a server (a “remote computer”) accessible to the user's local computer or may be stored on the local computer itself.

The set of movies from which selections are made could be as broad or narrow and as generic or as personal, as determined by the user. For example, a user could select a starting set comprised of comedies, Academy Awards-winning dramas, science fiction, movies starring a particular actor, or Christmas movies. A user could also begin with a set compiled from recently added or popular movies or a set compiled for the user's own selection data. In certain embodiments, a series of categories are presented to choose the selection set, while in others, the user could set selection parameters to create a custom starting set.

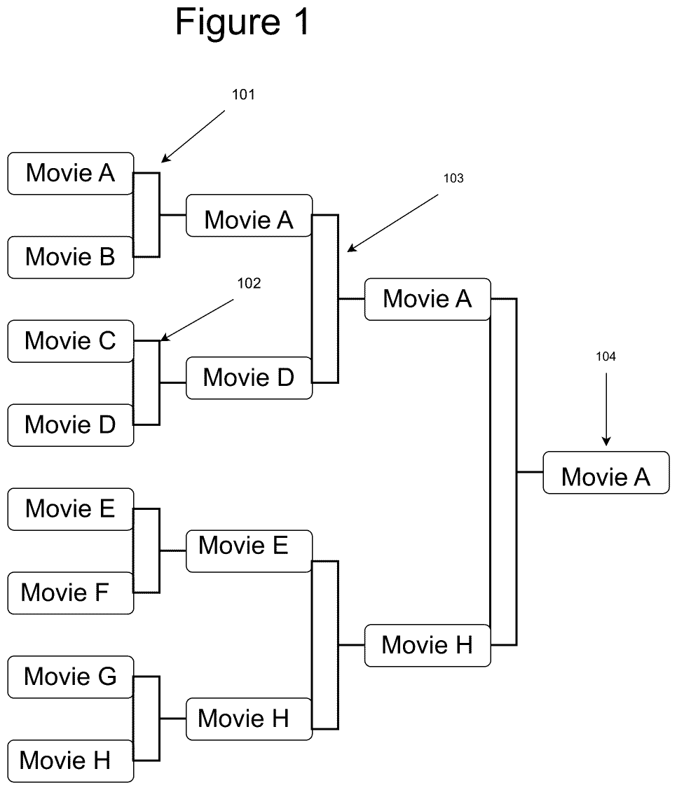

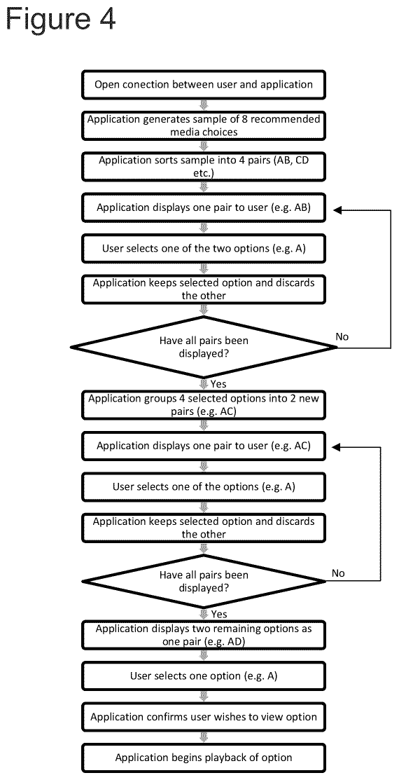

In a highly preferred embodiment, employing a methodology similar to a tournament bracket and illustrated in FIG. 1., an application presents a first choice (101) between two movies. The user selects a preferred movie, and a new selection is presented. The second choice (102) presented to the user is between two other movies. Subsequent choices presented continue to be between movies, each being presented for the first time during this selection process. Once a selected number of novel choices are presented, the application would present a second round of choices (e.g., 103), in which each paired presentation is a choice between two previously chosen movies. This pattern continues until a final movie is selected (104). FIG. 4 is a flowchart of an example of one implementation of this embodiment.

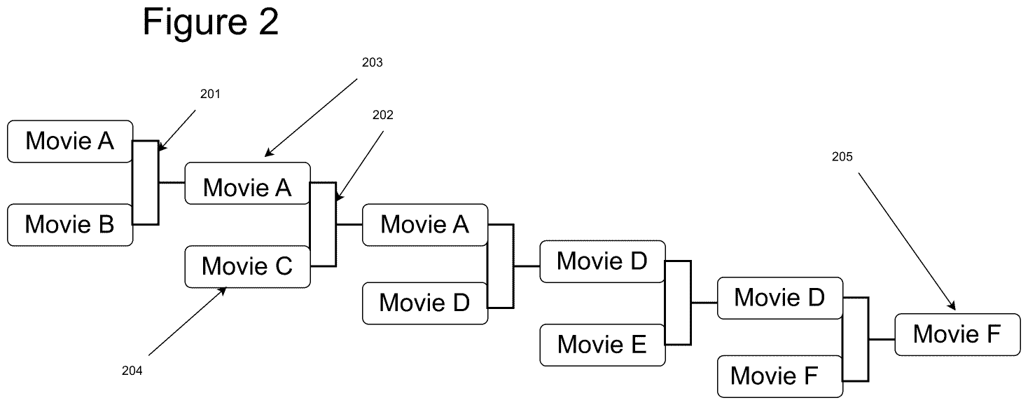

In another highly preferred embodiment, exemplified in FIG. 2., an application presents a first choice (201) between two movies. The user selects a preferred movie, and a new selection is presented. The second choice (202) presented to the user is between the movie selected in the previous step (203) and a movie being presented for the first time during this selection process (204). Subsequent selection rounds present a choice between the movie selected in the preceding round and a movie presented for the first during this selection process. Once the number of novel movies is exhausted, the final movie (205) is selected.

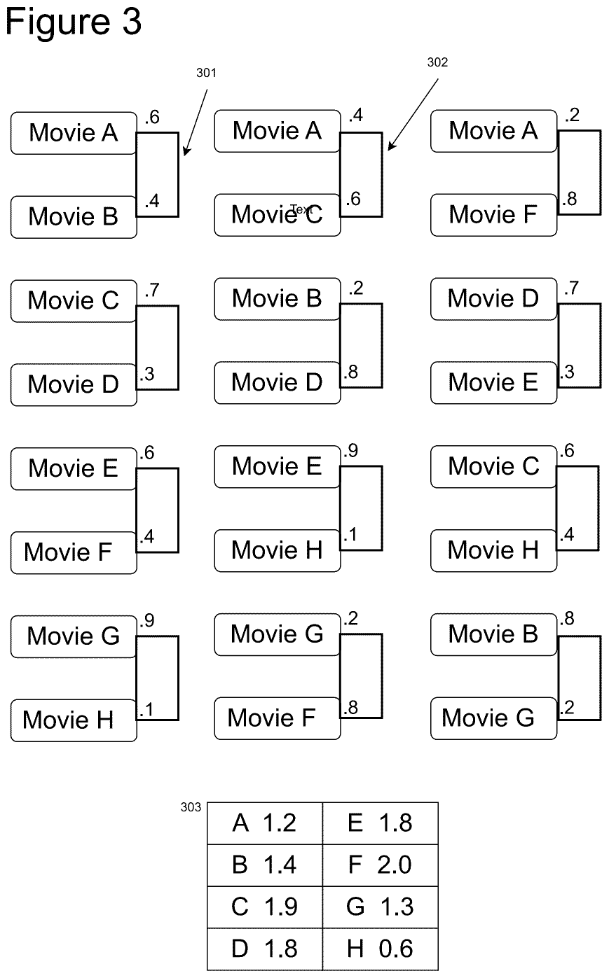

In yet another preferred embodiment exemplified in FIG. 3., a series of pairwise choices is presented to the user (e.g., 301 and 302). The user indicates the strength of the preference for one or the other movie along a continuum. For example, the user may move a digital representation of a slider between the two movies to indicate how much one is preferred. In this example, one movie is represented on the left of a screen, another movie is represented on the right of the screen, and a slider is centered between the two movies. The slider may be positionable along a scale from perhaps 0.4 on the left, to zero in the center, to 0.4 on the right. Moving the slider to the left would then indicate a preference for the movie on the left, while moving the slider to the right would indicate a preference for the movie on the right. After several rounds, or when all possible combinations of movies have been presented, the scores assigned to each movie are tabulated, and the movies are ranked accordingly (e.g., 303).

In the manner described above, this application's subject matter may be used to select a movie from a set of movies. This set of movies itself can be determined in a similar way. For example, one could use one of the disclosed pair-wise selection methods to choose a genre such as comedy, drama, action, etc. An additional or alternative pair-wise selection battery could be used to select increasingly narrow sub-genres such as horror-comedy, madcap comedy, teen comedy, etc.

Other embodiments of this application's subject matter could allow divergent selection batteries to converge or follow sequentially. For example, a first selection battery to choose genre may end with action movies. A following selection battery could build upon the preceding selection and present different categories of action movies, such as realistic, reality-based, sci-fi/fantasy, or martial arts. Additional rounds of refinement may prompt a choice between foreign or domestic movies, award winners, and box office successes or another discriminator. At any point, the user may make a final selection and begin watching a movie either through software comprising the subject matter of this application or through another service, optimally connected to the software comprising the subject matter of this application though an API or similar methodology.

The initial set of movies may encompass every movie, only those selections available on a certain service or services, or a smaller subset selected either by the user or for the user.

In most highly preferred embodiments, selection data is collected and used to present more relevant selections to a user. For example, the number of times a movie was presented and chosen could allow the calculation of a ranking for each moving in relation to other presented movies. Such data may be used to optimize the selection method for that user or may be accumulated across a group of users. To wit, if a user never selects from the genre of period dramas, period dramas will be presented less often. Or, if the movie “Encino Man” is never selected after some number of presentations, it may be removed from the user's selections. Also, as data from across users is gathered and analyzed, connections between movies will emerge and may be used to suggest better pairwise choices. For example, if users who like “The Lord of the Rings” also tend to like “Batman,” but tend not to like “The Godfather,” then “Batman” will be more likely to be suggested to others who like “Lord of the Rings.” In most embodiments, any user can reset their selection history or manually add liked or disliked movies to modify the selection pool. In this way, even after repeatedly ignoring “Encino Man” so it is removed from the selection set, one could still watch it and manually add it as a favored movie to use the subject matter of this application.

In another preferred embodiment, the method also assigns a dynamic rating to each movie presented to a user to further elucidate the user's general preferences. For example, a certain movie may be presented 28 times to a user across several selection batteries, selected 21 times, but never chosen as the final selection. In such a situation, that movie would be assigned a dynamic rating equal to the number of times it was selected divided by the number of times it was presented. In this example, that dynamic rating would be 0.75. Movies with higher dynamic ratings would be presented more often even though they may have never been finally selected.

1. A method for selecting a member of a set by a user comprising the steps of:
a. Selecting two members of a set of unselected items,
b. Presenting the pair of members of the set to a user,
c. Prompting the user to choose a selected member from one of the two members of the set,
d. Rejecting the unselected member of the pair,
e. Selecting another two members of the set,
f. Presenting the second pair of members to a user,
g. Prompting the user to choose a selected member from one of the newly presented members of the set,
h. Rejecting the unselected member of the pair,
i. Continuing to make pairwise selections between unselected and selected members of the set until all set members are either selected or rejected.

2. The method of claim 1 in which the number of members within the set is determined by a user.

3. The method of claim 1 in which the members of the set are determined by set management software implemented on a computer.

4. The method of claim 1 in which the members of the set are determined by a user.

5. The method of claim 1 in which the members of the set are selected from a larger set of items sharing at least on characteristic.

6. The method of claim 1 in which the steps are executed on a local computer.

7. The method of claim 1 in which at least some of the steps are executed on a remote computer in communication with a local computer.
